(19) United States
(12) Patent Application Publication
(10) Pub. No.: US 2006/0174493 A1
(43) Pub. Date: Aug. 10, 2006

(54) Combination of spoon and clip

(76) Inventor: James Hsu, Kee-Lung City (TW)

Correspondence Address: LIN & ASSOCIATES INTELLECTUAL PROPERTY, P.O. BOX 2339, SARATOGA, CA, 95070-0339, US

(21) Appl. No.: 11/052,639

(22) Filed: Feb. 5, 2005

(51) Int. Cl. A47J 43/28

(52) U.S. Cl. 30/324

(57) ABSTRACT

A spoon includes a bowl and a handle extending from the bowl. The handle includes first and second bars. The first bar has a proximal end connected to the bowl and forming a resilient projection having an barbed free end and a distal end forming a hinge with a distal end of the second bar whereby the second bar is rotatable with respect to the first bar between a closed position and an open position to realize a clip for clamping for example a food storage bag. The second bar has a proximal end forming an extended flange releasably engageable with the barbed end of the projection of the first bar to releasably secure the second bar to the first bar in the closed position.

### BACKGROUND OF THE INVENTION

1. Field of the Invention

The present invention relates generally to kitchen utensils, and in particular to a spoon having a handle forming a clip for sealing for example a flavor bag or a bag containing food.

2. The Prior Arts

Spoons are one of the most common table cutleries, which are used in for example drinking soup or dessert. The spoons are also useful kitchen utensils, housewives and chefs use spoon to measure a predetermined amount of flavor. On the other hand, flavors or other foods are often stored in bags, such as plastic bags. To protect the foods stored in bags from getting wetted or contaminated, it is common to tighten/seal the bag opening with a clip. A housewife or chef must remove the clip from the flavor bag first and then uses a spoon to measure a desired amount of the flavor stored in the bag. Once this is done, the clip must be put back to secure the bag opening again. This is often troublesome for a busy chef. For example, in a busy kitchen of for example a famous restaurant, the chef may get too busy to remember where he or she put the clip that is just removed from the flavor bag, or it is hard for the chef to immediately get a measuring spoon after removing the clip.

It is thus desired to provide a kitchen utensil to overcome such a trouble that a chef or housewife often faces.

### SUMMARY OF THE INVENTION

An objective of the present invention is to provide a combination of spoon and bag clip wherein the clip secures an opening of a flavor bag and the spoon helps measuring a predetermined amount of flavor or food stored in the bag once the clip is removed from the bag opening.

Another objective of the present invention is to provide a spoon having a handle that forms a clip for selectively securing an opening of a food storage bag.

In accordance with the present invention, to realize the above objectives, a spoon is provided, comprising a spoon bowl and a handle extending from the spoon bowl. The handle comprises two overlapping bars of which the first one has a proximal end connected to the spoon bowl and forms a resilient projection having a barbed free end in the proximate of the connection. The second bar has a distal end connected to the distal end of the first bar by a hinge, which may be formed by a section of reduced thickness/width that allows for bending or rotation of the second bar with respect to the first bar. The second bar has a proximal end forming an extended flange corresponding in position to and engageable with the barbed end of the projection of the first bar for releasably securing the second bar to the first bar in an overlapping condition. One of the bars is provided with a raised rib in an inner face thereof and substantially co-extensive therewith and the other one of the bars forms a slot in an inner face thereof for receiving the rib therein. The slot has a cross-sectional area slightly larger than cross-sectional dimension of the rib whereby a portion of a bag, preferably adjacent an opening of the bag, can be interposed between the bars and fixed and tightly clamped in the slot by being depressed by the rib, thereby securing/sealing the opening of the bag.

The present invention will become more obvious from the following description when taken in connection with the accompanying drawings, which show, for purposes of illustration only, a preferred embodiment in accordance with the present invention. In the drawings:

### BRIEF DESCRIPTION OF THE DRAWINGS

FIG. 1 is a perspective view of a spoon constructed in accordance with the present invention, having a handle forming a clip in a closed state;

FIG. 2 is a perspective view of the spoon with the clip opened; and

FIG. 3 is a cross-sectional view of the spoon showing the clip in an open state.

### DETAILED DESCRIPTION OF THE PREFERRED EMBODIMENTS

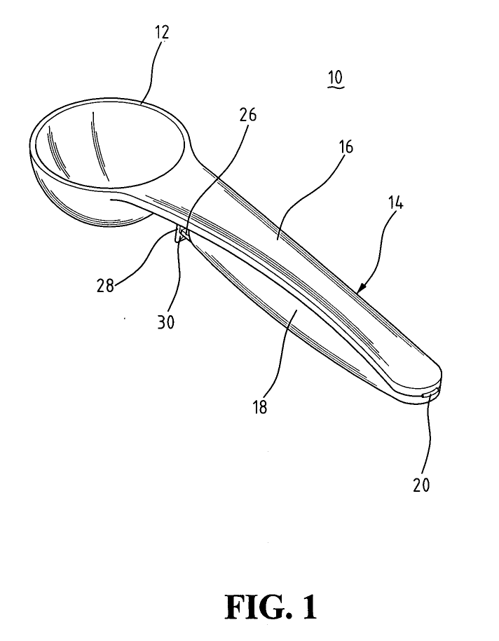

With reference to the drawings, and in particular to FIG. 1, a spoon constructed in accordance with the present invention, generally designated with reference numeral 10, comprises a spoon bowl 12 and an handle 14 extending from one end of the bowl 12. The bowl 12 is generally circular in cross-section, which makes the bowl hemispherical, such as teaspoon and a measuring spoon. It is also possible to make the bowl 12 of other shapes, such as that having an oval cross-section, for example a soup spoon and a desert spoon. The handle 14 is generally of an elongate bar like configuration, having a proximal end connected to the bowl 12 and an opposite distal end for hand-holding.

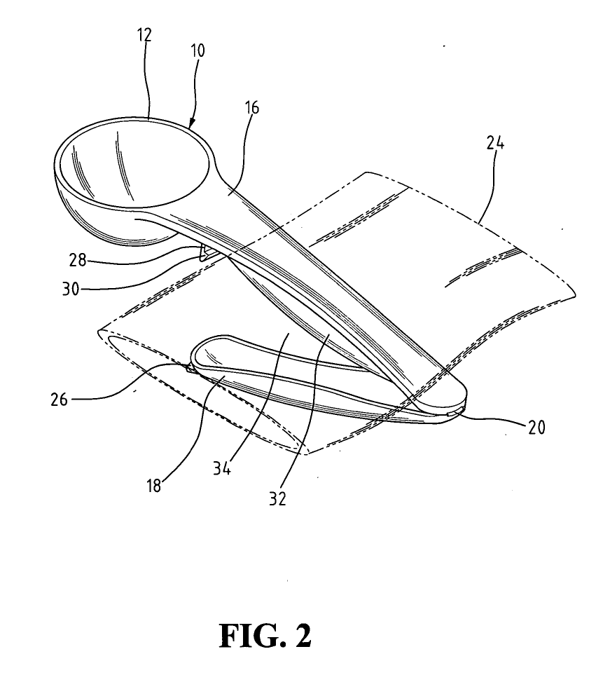

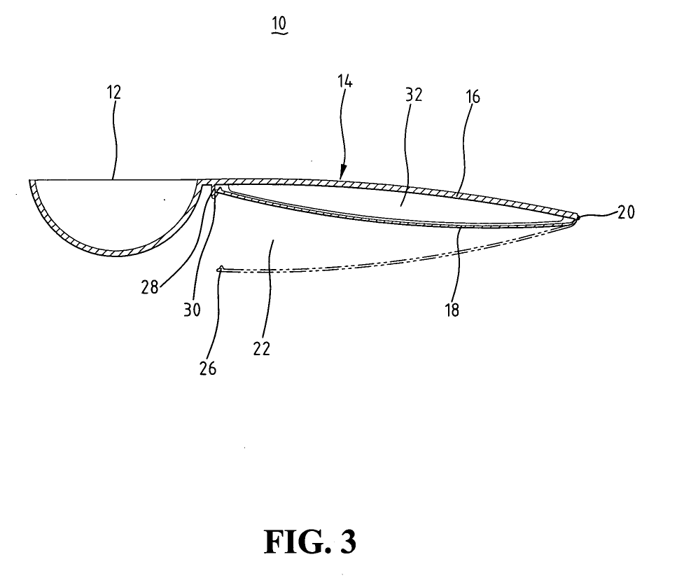

Also referring to FIGS. 2 and 3, the handle 14 is comprised of first and second bars 16, 18 that overlap and co-extend with each other to form the handle 14. The first bar 16 has a proximal end connected to the bowl 12 to serve as the connection between the handle 14 and the bowl 12. An opposite distal end of the first bar 16 forms a hinge 20, best seen in FIG. 3, that connects a distal end of the second bar 18 whereby the second bar 18 is rotatable about the hinge 20 to approach or move away from the first bar 16. When the second bar 18 moves to and overlaps the first bar 16 (FIG. 1 and solid lines of FIG. 3), the first and second bars 16, 18 together form the handle 14. When the second bar 18 moves away from the first bar 16 (FIG. 1 and phantom lines of FIG. 3), a gap 22 is formed between the first and second bars 16, 18, which allows for extension of for example an open end of a food storage bag or bags of other purposes (see reference numeral 24 of FIG. 2).

The hinge 20 can be formed by a section of reduced thickness and/or reduced width between the distal ends of the first and second bars 16, 18, particularly when the first and second bars 16, 18 are integrally formed by plastic molding. The reduced thickness/width makes the portion of the molded plastic that forms the hinge 20 flexible and thus allows portions of the molded plastic on opposite sides of the reduced thickness portion to rotate with respect to each other, thereby realizing the hinge 20.

The second bar 18 has a proximal end forming an extended flange 26. At a position corresponding to the flange 26, a resilient projection 28 extends from the first bar 16 and has a free end forming a barb 30 that is engageable with the flange 26 to secure the second bar 18 at an overlapping condition with the first bar 16, thereby forming the handle 14.

The barb 30 is resiliently supported by the projection 28 and preferably forms an inclined camming face (not labeled), which helps engaging the barb 30 through the flange 26 for securing the second bar 18 to the first bar 16. The resiliency of the projection 28 allows the barb 30 to manually displace to disengage from the flange 26 for releasing the second bar 18 from the first bar 16.

The opening of the bag 24 is sealed by moving the second bar 18 to the overlapping position and secured to the first bar 16. The overlapped first and second bars 16, 18 clamp the open end of the bag 24 therebetween and thus closing and sealing the opening of the bag 24. Thus, the first and second bars 16, 18, together with the hinge 20 and the barbed projection 26, form a clip for closing and sealing a bag.

To enhance sealing between the first and second bars 16, 18, one of the bars, such as the first bar 16 in the embodiment illustrated, forms a raised rib 32 substantially co-extensive with the first bar 16, and the other one of the bars, such as the second bar 18, forms an elongate slot 34 co-extensive with the second bar 18 for receiving the rib 32 therein when the clip is closed (that is the first and second bars 16, 18 overlapping each other). The rib 32 can be of a convex configuration as illustrated in the drawings, or alternatively, the rib 32 can be a straight flat strip. The rib 32 has a cross-sectional dimension that is smaller than the cross-sectional area of the slot 34 so that a gap surrounding the rib 32 is formed between the rib 32 and the slot 34 for accommodating the thickness of the bag 24 clamped between the first and second bars 16, 18.

To remove the bag 24 from the clip, one releases the barb 30 from the flange 26 to separate the second bar 18 from the first bar 16 to open the clip. The bag 24 is thus allowed to move away from the clip. In one application of the present invention, after the bag 24 is removed from the clip, the first and second bars 16, 18 are fixed together again to serve as the handle of the spoon and one can use the spoon 10 by holding the handle 14 to take or measure a specific amount of for example seasoning stored in the bag 24. After the specific amount of seasoning is taken from the bag 24, one can separates the first and second bars 16, 18 to open the clip and put the open end of the bag 24 back into the gap 22 between the first and second bars 16, 18 and then close the clip again by securing the second bar 18 to the first bar 16. The bag 24 is thus sealed again.

Although the present invention has been described with reference to the preferred embodiment thereof, it is apparent to those skilled in the art that a variety of modifications and changes may be made, for example replacing the bowl with a fork, without departing from the scope of the present invention which is intended to be defined by the appended claims.

What is claimed is:

1. A spoon comprising: a bowl; and
a handle connected to the bow, the handle comprising:
a first bar having a proximal end connected to the bowl and a distal end forming a hinge, and a second bar having a distal end connected to the distal end of the first bar by the hinge to allow the second bar to selectively rotate with respect to first bar whereby the second bar is movable between a first position where the second bar overlaps the first bar to form the handle and a second position where the second bar is separate from the first bar to serve as a clip for clamping an external object between the first and second bars.

2. The spoon as claimed in claim 1 further comprising means for securing a proximal end of the second bar thereby releasably retaining the second bar in the first position.

3. The spoon as claimed in claim 2, wherein the securing means comprises a resilient barb formed on the first bar and releasably engageable with the proximal end of the second bar.

4. The spoon as claimed in claim 3, wherein the proximal end of the second bar forms an extended flange engageable with the resilient bar.

5. The spoon as claimed in claim 1 further comprising means for tightly clamping the external object between the first and second bars.

6. The spoon as claimed in claim 5, wherein the means for tightly clamping the external object comprises a rib formed along one of the bars and a corresponding slot defined along the other one of the bars for receiving the rib therein.

7. The spoon as claimed in claim 6, wherein the rib has a convex configuration.

8. The spoon as claimed in claim 6, wherein the rib has a cross-sectional dimension smaller than cross-sectional area of the slot.

9. The spoon as claimed in claim 3 further comprising means for tightly clamping the external object between the first and second bars.

10. The spoon as claimed in claim 9, wherein the means for tightly clamping the external object comprises a rib formed along one of the bars and a corresponding slot defined along the other one of the bars for receiving the rib therein.

11. The spoon as claimed in claim 10, wherein the rib has a convex configuration.

12. The spoon as claimed in claim 10, wherein the rib has a cross-sectional dimension smaller than cross-sectional area of the slot.
